(19) United States
(12) Patent Application Publication
(10) Pub. No.: US 2014/0352897 A1
(43) Pub. Date: Dec. 4, 2014

(54) Bottom Load Bracket For An Architectural Covering

(71) Applicant: Qmotion Incorporated, Pensacola, FL (US)

(72) Inventors: Willis J. Mullet, Gulf Breeze, FL (US); Christopher L. Wysoczynski, Gulf Breeze, FL (US)

(73) Assignee: Qmotion Incorporated, Pensacola, FL (US)

(21) Appl. No.: 14/283,471

(22) Filed: May 21, 2014

Related U.S. Application Data
(60) Provisional application No. 61/827,817, filed on May 28, 2013.

(51) Int. Cl. E06B 9/42

(52) U.S. Cl. CPC E06B 9/42
USPC 160/323.1; 160/368.1; 29/428

(57) ABSTRACT

An architectural covering with a roll tube rotatably connected to mounting brackets at opposing ends and having shade material wrapped around the roll tube. The roll tube has a hollow interior with a motor assembly, a battery tube assembly and a spring assembly positioned within the hollow interior of the roll tube. One end of the architectural covering is mounted to a top loading bracket whereas the opposite end of the architectural covering is connected to a bottom loading bracket. The bottom loading bracket includes a recessed portion having an axel opening and a deflectable clip member that covers the axel opening. As an axel is inserted into the bracket, the clip member deflects allowing the axel to enter the axel slot and the clip member locks the axel into the axel slot. In this way an improved method of installing architectural coverings is presented.

### CROSS REFERENCE TO RELATED APPLICATION

This application claims the benefit of U.S. Provisional Application No. 61/827,817 filed May 28, 2013.

### FIELD OF THE INVENTION

This invention relates to an architectural covering. More specifically, and without limitation, this invention relates to a bottom load bracket for an architectural covering.

### BACKGROUND OF INVENTION

Architectural coverings, such as curtains, shades, draperies and the like are frequently used to provide privacy and to limit the amount of light that is permitted to pass through a window and into a room or building. There are countless types, forms and designs of architectural coverings known in the art. The term architectural covering is used to describe any and all of these types, forms and designs including blinds, shades, draperies, and the like.

One form of architectural covering of particular interest in this application is a roll shade. Common components of roll shades include a roll tube rotatably connected to brackets on opposing ends. The roll shade is positioned above or adjacent to a window or door. In one arrangement of a roll shade, shade material is wrapped around the roll tube, as the roll tube rotates the shade material wrapped or unwrapped around the roll tube thereby opening and closing the roll shade.

Brackets are used in conventional roll shade applications to connect the roll shade to a window opening, a doorway or other part of a structure. Many conventional brackets are complex, cumbersome, aesthetically displeasing or suffer from countless other deficiencies.

More specifically, many conventional brackets are difficult to install into the window opening and it is difficult to install the roll shade onto the brackets themselves. This is because many brackets require the shade to be held into the bracket by the force of gravity, and this requires the user to lower the shade into the bracket. However, when the shade is to be mounted as high as possible against the top of a window pocket, there is no room to lower the shade into the bracket. In addition, conventional brackets have no mechanism that locks the roll shade into the bracket and therefore these brackets provide little to no assurance that the roll shade will not unintentionally come out of the bracket and cause a safety problem. Further conventional brackets for architectural coverings provide little to no adjustability and therefore require precise installation which is often difficult or impossible to accomplish in many applications.

These and other problems exist in the architectural covering bracket art.

Thus it is a primary object of the invention to provide a bottom load bracket for an architectural covering that improves upon the state of the art.

Another object of the invention is to provide a bottom load bracket for an architectural covering that is easy to use.

Yet another object of the invention is to provide a bottom load bracket for an architectural covering that is efficient.

Another object of the invention is to provide a bottom load bracket for an architectural covering that is simple in design.

Yet another object of the invention is to provide a bottom load bracket for an architectural covering that is inexpensive.

Another object of the invention is to provide a bottom load bracket for an architectural covering that has a minimum number of parts.

Yet another object of the invention is to provide a bottom load bracket for an architectural covering that has an intuitive design.

Another object of the invention is to provide a bottom load bracket for an architectural covering that allows for bottom loading of the architectural covering into the bracket.

Yet another object of the invention is to provide a bottom load bracket for an architectural covering that has a long useful life.

Another object of the invention is to provide a bottom load bracket for an architectural covering that provides adjustability.

Yet another object of the invention is to provide a bottom load bracket for an architectural covering that prevents unintentional disengagement of the architectural covering from the bracket.

Another feature is to provide a bottom load bracket that also serves as an attachment for a fascia or covering for the roller shade fabric.

Yet another feature is to provide a bottom load bracket that serves for both standard roll fascia attachment as well as a reverse roll fascia attachment.

These and other objects, features, or advantages of the present invention will become apparent from the specification and claims.

### SUMMARY OF THE INVENTION

An architectural covering is presented having a roll tube rotatably connected to mounting brackets at opposing ends and having shade material wrapped around the roll tube. The roll tube has a hollow interior. A motor assembly, a battery tube assembly and a spring assembly are positioned within the hollow interior of the roll tube. One end of the architectural covering is mounted to a top loading bracket whereas the opposite end of the architectural covering is connected to a bottom loading bracket. The bottom loading bracket includes a recessed portion having an axel opening and a pair of angled shoulders which connect to an axel slot. A clip member covers a portion of the axel opening and the axel slot and is biased toward the bottom loading bracket. An axel is inserted into the axel slot by inserting the axel into the axel opening and forcing the axel upwardly into the axel slot, thereby overcoming the bias of the clip member. Once the axel is in position within the axel slot, the clip member locks the axel into the axel slot. In this way an improved method of installing architectural coverings is presented.

### BRIEF DESCRIPTION OF THE DRAWINGS

FIG. 1 is a perspective view of an architectural covering having a unit frame, a roll tube, shade material wrapped around the roll tube and a bottom bar; the architectural covering positioned within a window opening, the roll tube rotatably connected to mounting brackets.

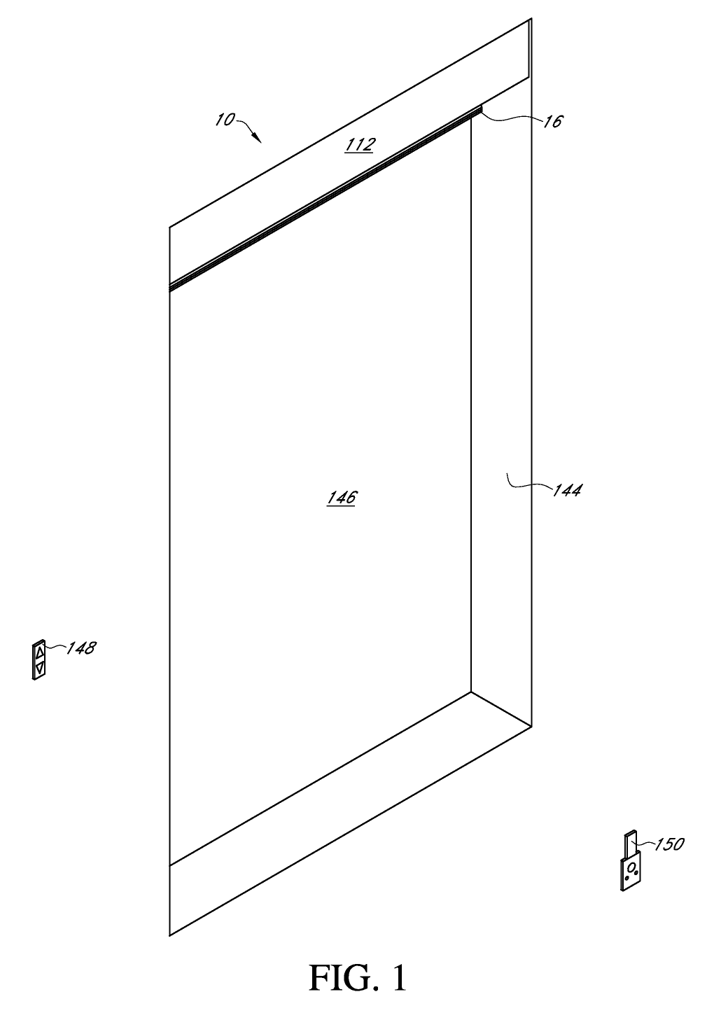

FIG. 2 is a perspective view of an architectural covering having end covers, a unit frame, a roll tube, shade material wrapped around the roll tube and a bottom bar, the roll tube rotatably connected to mounting brackets.

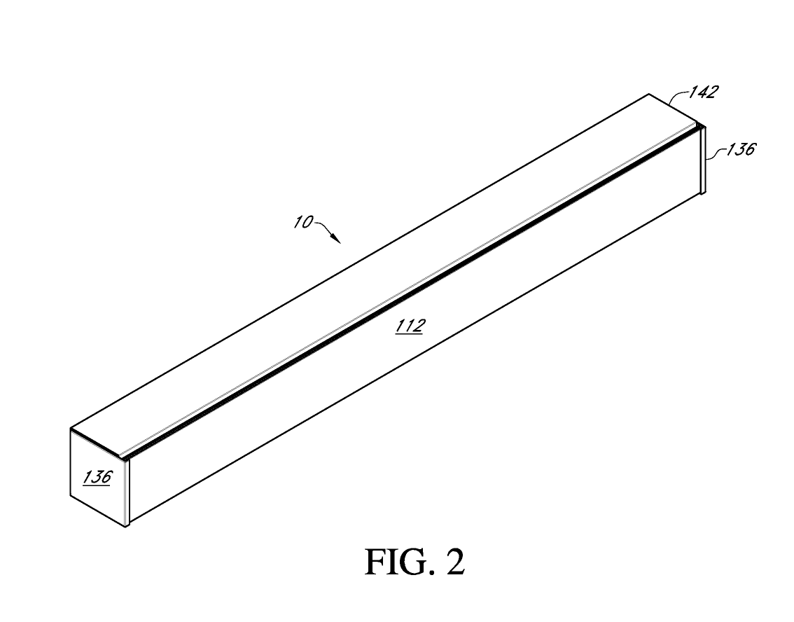

FIG. 3 is an elevation view of the end of an architectural covering having a roll tube, shade material wrapped around the roll tube and a bottom bar, the roll tube rotatably connected to a mounting bracket.

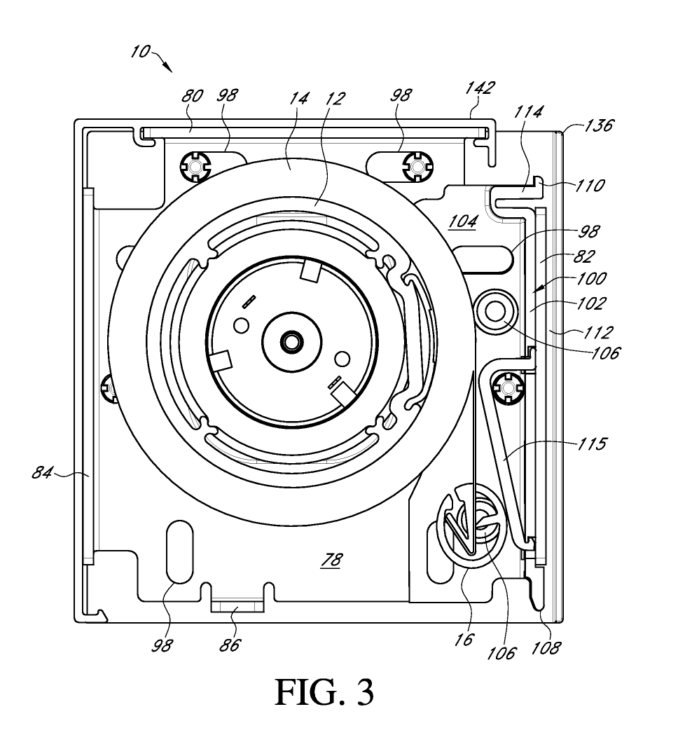

FIG. 4 is an exploded perspective of an architectural covering having a roll tube with axel shafts extending out of the ends of the roll tube, shade material wrapped around the roll tube and a bottom bar connected to the shade material, a unit frame, a front cover and a pair of mounting brackets having end covers.

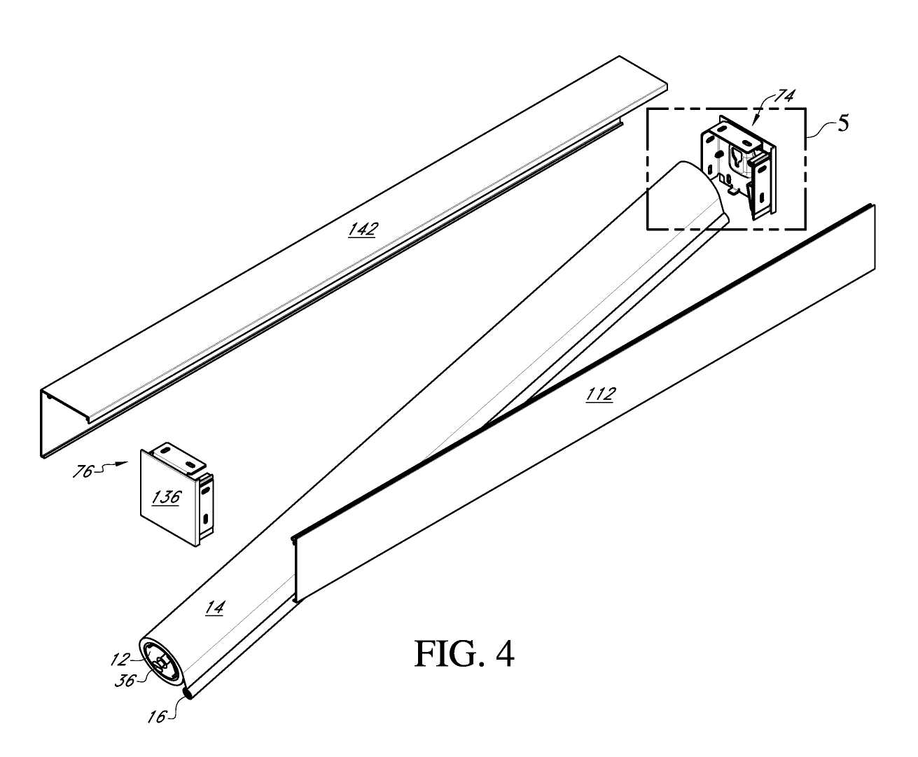

FIG. 5 is perspective view of a right side top loading mounting bracket showing the architectural covering spaced away from the mounting bracket.

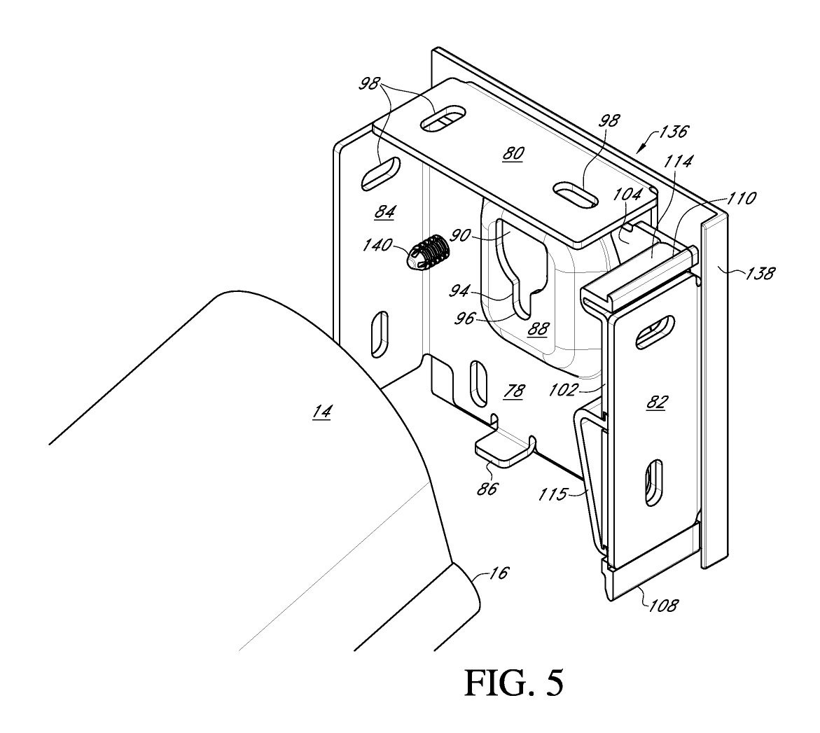

FIG. 6 is an exploded perspective of an architectural covering having a roll tube with axel shafts extending out of the ends of the roll tube, shade material wrapped around the roll tube and a bottom bar connected to the shade material, a unit frame, a front cover and a pair of mounting brackets having end covers.

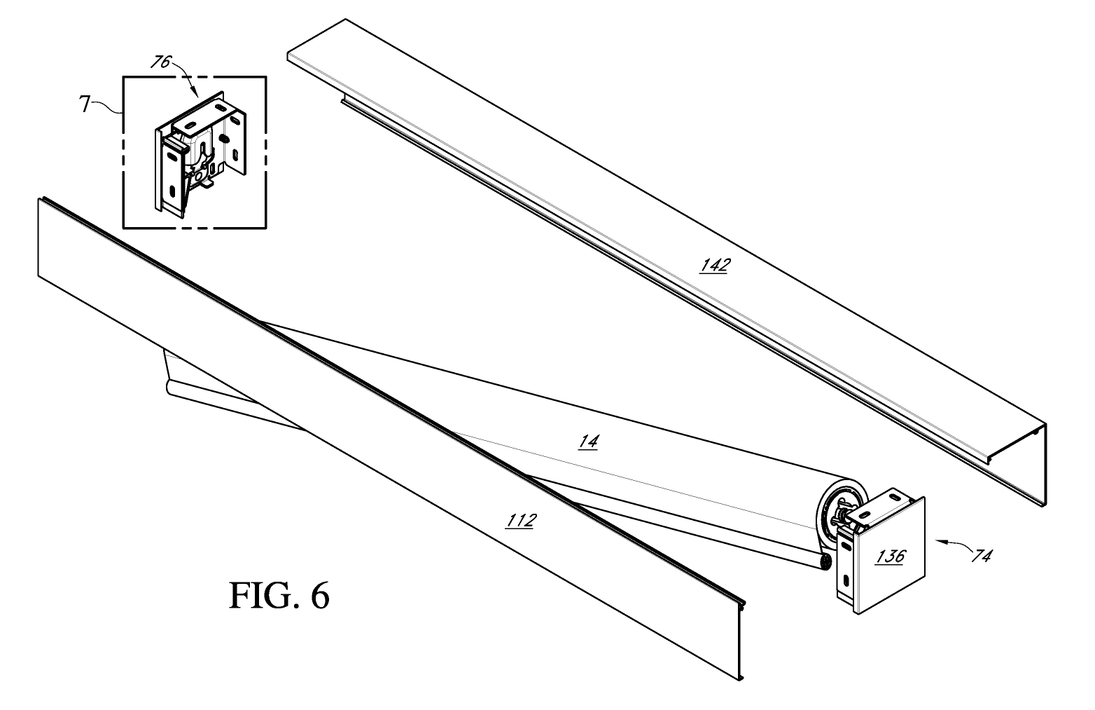

FIG. 7 is perspective view of a left side bottom loading mounting bracket.

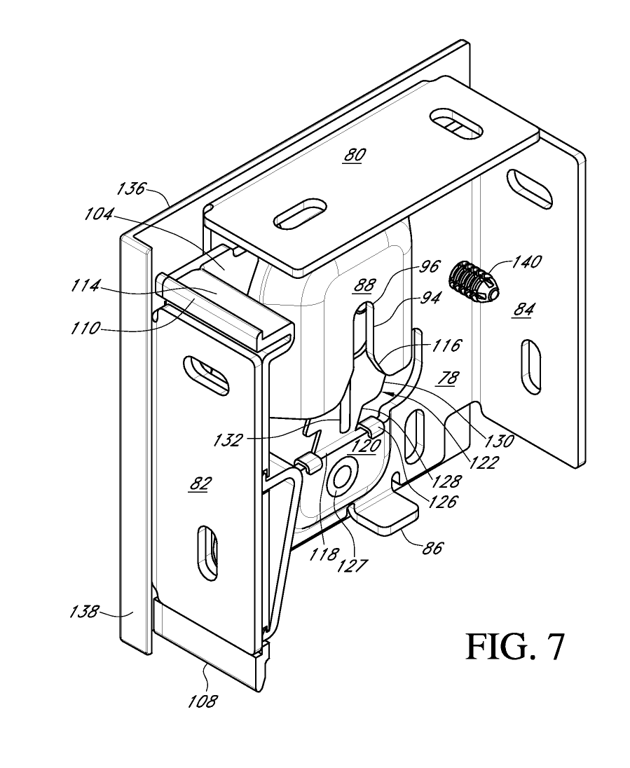

FIG. 8 is an exploded perspective of an architectural covering having a roll tube, shade material wrapped around the roll tube and a bottom bar connected to the shade material, a unit frame, a front cover and a pair of mounting brackets having end covers, the view shows the architectural covering assembled, other than the unit frame and the front cover being exploded away from the other parts.

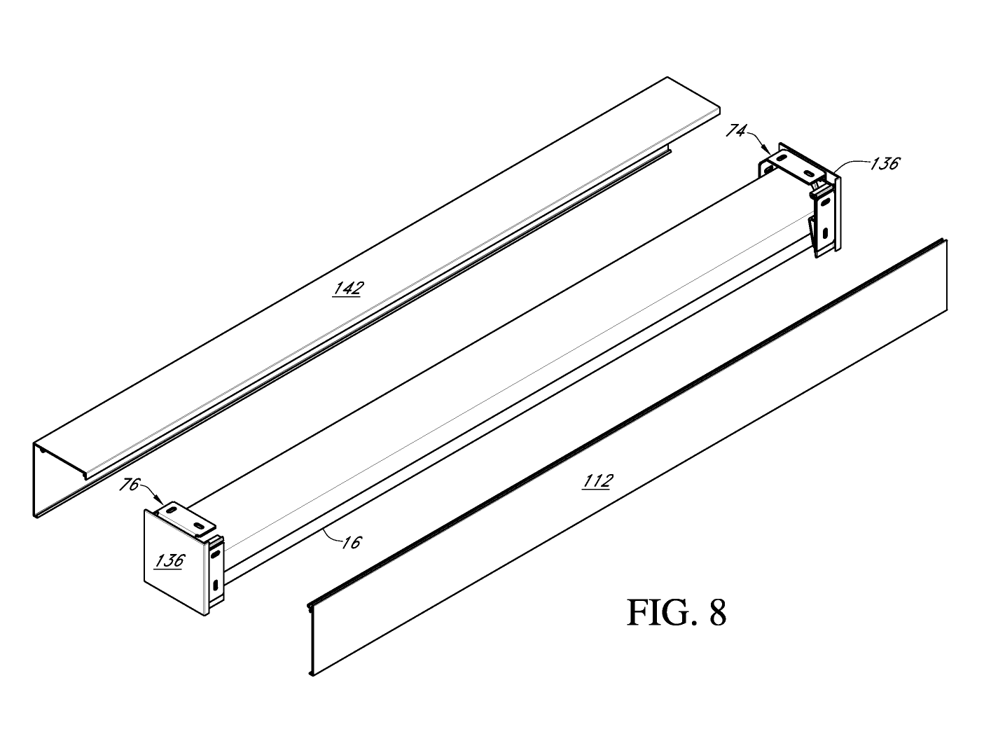

FIG. 9 is an exploded perspective of a motorized architectural covering having a roll tube, shade material and a bottom bar, a unit frame, a front cover a pair of mounting brackets and end covers, the view shows the counterbalance assembly, battery assembly, motor assembly and bearing housing that are positioned within the hollow interior of the roll tube.

FIG. 10 is an exploded perspective of a manual architectural covering having a roll tube, shade material and a bottom bar, a unit frame, a front cover a pair of mounting brackets and end covers, the view shows the counterbalance assembly, a bearing housing and a dampener that are positioned within the hollow interior of the roll tube.

FIG. 11 is an elevation cut-away view of the right side of the assembled architectural covering shown in FIG. 9 installed onto a top loading mounting bracket, the view showing the axel shaft inserted into the bracket, the bearing housing and the motor assembly connected to the axel shaft.

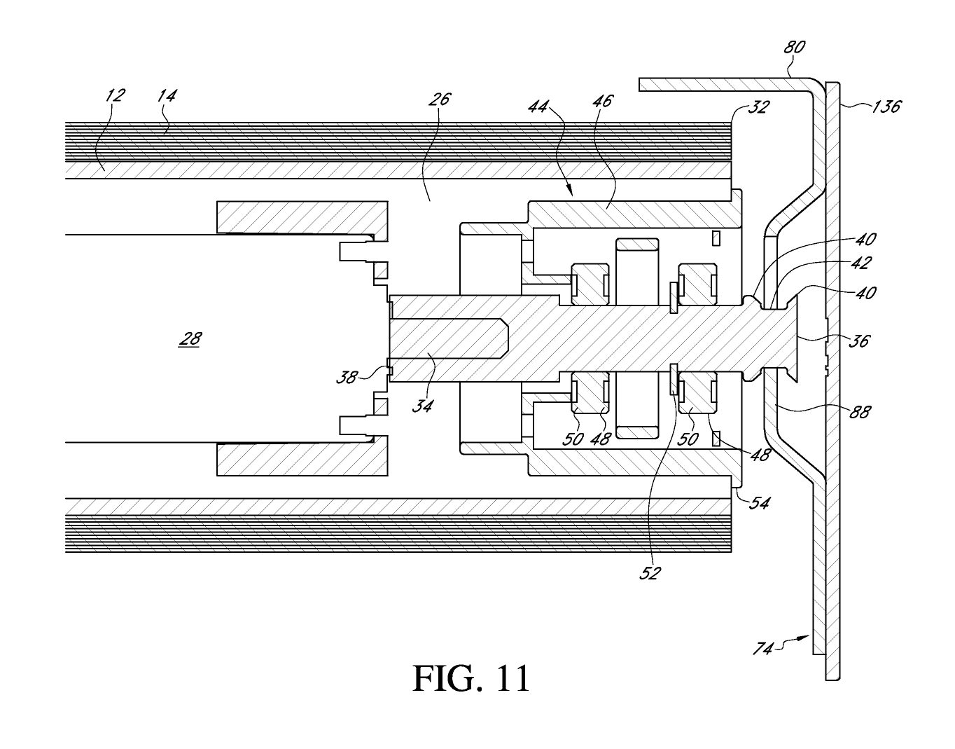

FIG. 12 is an elevation cut-away view of the left side of the assembled architectural covering of FIG. 9 installed onto a bottom loading mounting bracket, the view showing the axel shaft inserted into the bracket, the bearing housing and the counterbalance assembly connected to the axel shaft.

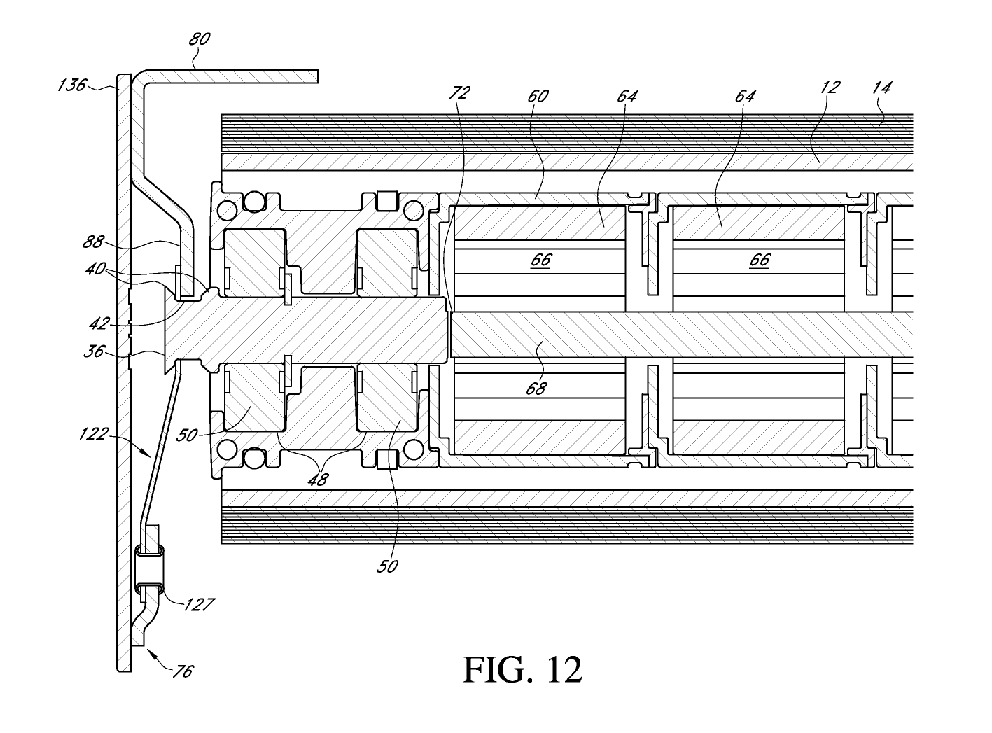

### DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that other embodiments may be utilized and that mechanical, procedural, and other changes may be made without departing from the spirit and scope of the present inventions. The following detailed description is, therefore, not to be taken in a limiting sense, and the scope of the present invention is defined only by the appended claims, along with the full scope of equivalents to which such claims are entitled.

As used herein, the terminology such as vertical, horizontal, top, bottom, front, back, end and sides are referenced according to the views presented. It should be understood, however, that the terms are used only for purposes of description, and are not intended to be used as limitations. Accordingly, orientation of an object or a combination of objects may change without departing from the scope of the invention.

As used herein, the invention is shown and described as being used in association with an architectural covering, namely a roller shade, a roll shade or similar device. However the invention is not so limiting. Instead, one of ordinary skill in the art will appreciate that the system and method presented herein can be applied to any form of an architectural covering, shade or blind, or even any mechanical device, without limitation. The system and method is merely shown and described as being used in association with an architectural covering for ease of description and as one of countless examples.

As used herein, the term architectural covering refers to any covering such as a blind, drapery, roller shade, venetian blind, drapery or the like, used especially in association with windows. This term is in no way meant to be limiting. Instead, one of ordinary skill in the art will appreciate that the system and method presented herein can be applied to any architectural covering, without limitation.

With reference to the figures, an architectural covering 10 is presented. Architectural covering 10 is formed of any size, shape and design. As one example, as is shown, architectural covering 10 is a roll shade such as that manufactured by QMotion Incorporated, located at 3400 Copter Road, Pensacola, Fla. and further claimed and described in: U.S. Pat. No. 8,299,734, filed on Feb. 23, 2010 with application Ser. No. 12/711,192 entitled High Efficiency Roller Shade; U.S. Pat. No. 8,575,872, filed on Oct. 17, 2012 with application Ser. No. 13/653,451 entitled High Efficiency Roller Shade and Method For Setting Artificial Stops; and U.S. Pat. No. 8,368,328,734, filed on Feb. 23, 2010 with application Ser. No. 12/711,193 entitled Method for Operating A Motorized Roller Shade, which are all fully incorporated by reference herein, along with any and all other related patents and patent applications.

In the arrangement shown, architectural covering 10 includes a roll tube 12 and shade material 14 is connected at its upper end to roll tube 12 and is wrapped around the exterior surface of the roll tube 12 such that when the roll tube 12 is rotated in a one direction the architectural covering 10 is opened, whereas when the roll tube 12 is rotated in a second direction the architectural covering 10 is closed. A bottom bar 16 is connected to the lower end of shade material 14. A shade material attachment member 18 is connected to the upper end of shade material 14. Shade material attachment member 18 is formed of any size, shape or design. As one example, in the arrangement shown, shade material attachment member 18, is an elongated plastic or composite extrusion which is sized and shaped to lockingly fit within a mounting slot 20 in the surface of roll tube 12. Other than the mounting slot 20, the surface of roll tube 12 is generally circular or tubular in shape. Roll tube 12 extends a length between a right end 22 and a left end 24 and has a hollow interior 26 that extends therebetween.

Motor Housing:

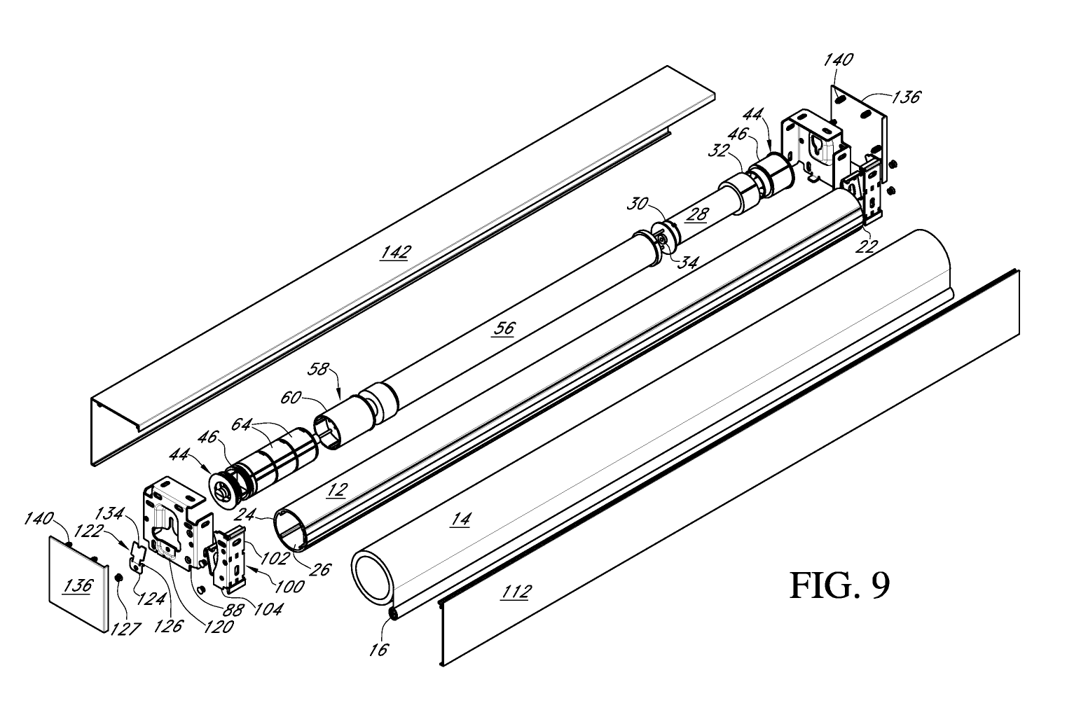

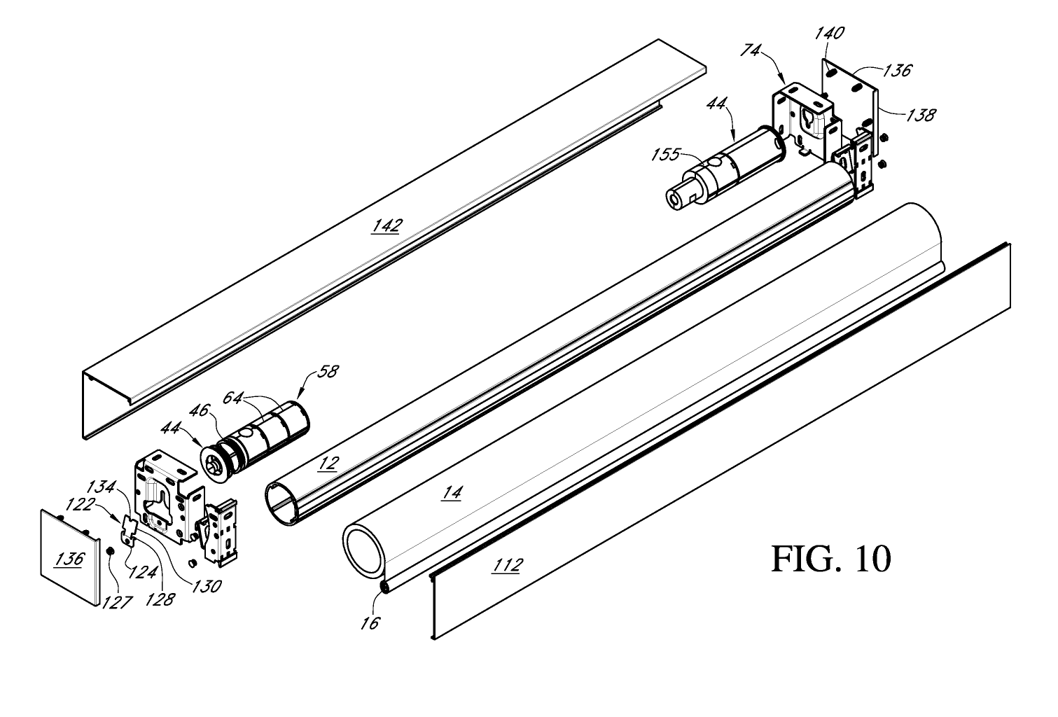

The system and method shown and described herein can be used with a motorized system, shown in FIG. 9, and a non-motorized system, shown in FIG. 10, with equal applicability.

With reference to FIG. 9, a motor housing 28 is positioned within the hollow interior 26 of roll tube 12 adjacent its right end 22. Motor housing 28 is formed of any suitable size and shape. In one arrangement, as is shown, motor housing 28 has a generally elongated tubular shaped exterior surface which fits within the hollow interior 26 of roll tube 12.

Motor housing 28 extends between an interior end 30 and an exterior end 32 and has an open or hollow interior compartment. Positioned within the open interior compartment of motor housing 28 is a motor and transmission which are connected to one another. The motor is any form of a motor that converts electrical energy to mechanical energy and provides rotation and torque. The transmission is any form of a device that transmits rotation of the motor and gears to a different rotational speed such as a gear box, a planetary gear box or the like. The transmission transmits the rotation of the motor and converts into the desirable speed useful for the application. The transmission helps to maximize the torque produced by the motor while maximizing battery life.

Motor housing 42 also includes a motor controller (not shown) which is electrically connected to the motor of motor housing. A motor controller is more fully described in Applicant's related patent application Ser. No. 61/817,954, filed in the United States Patent and Trademark Office on the 1st day of May 2013, entitled Motorized Drapery Apparatus, System And Method Of Use, which is incorporated by reference fully herein including any and all related patent applications. In that arrangement and in the arrangement shown, the motor controller is positioned within motor housing 28 and is connected adjacent the interior end 30 of motor housing 28. The motor controller includes all the components to control the motor and to control operation of the architectural covering 10 in a stand-alone self-contained unit which can be inserted into and removed from roll tube 12 without any tools, wires, bolts, screws or nuts. The motor controller is any device which controls the operation of the motor. In one arrangement, the motor controller is an electrical circuit board or PC board which is electrically connected to a microprocessor connected to memory, a receiver or transceiver and an antenna. The microprocessor is any programmable device that accepts analog or digital signals or data as input, processes it according to instructions stored in its memory, and provides results as output. Microprocessor receives signals from the receiver or transceiver and processes them according to its instructions stored in its memory and then controls the motor based on these signals. The memory is any form of electronic memory such as a hard drive, flash, ram or the like. The antenna is any electronic device which converts electric power into electromagnetic signals or electromagnetic waves, which are commonly known as radio waves or RF (radio frequency) (hereinafter collectively referred to as “electromagnetic signals” without limitation). The antenna transmits and/or receives these electromagnetic signals. In one arrangement these electromagnetic signals are transmitted via AM or FM RF communication, while any other range of RF is hereby contemplated such as 433 MHz or 908 MHz, or the like.

To detect rotation and track the position of roll tube 12, a sensor assembly is connected to motor housing 28. Sensor assembly is any form of a device which senses the rotation or position of architectural covering 10, such as reed switches, mechanical encoders, magnetic encoders, or the like. In one arrangement, sensor assembly includes a magnet wheel connected to a secondary motor shaft extending outwardly from the interior end of the motor such that when the motor rotates, secondary motor shaft rotates, thereby rotating the magnetic wheel. Positioned adjacent to magnet is a pair of Hall Effect sensors positioned opposite one another. In this arrangement, the Hall Effect sensors are connected to the PC board adjacent the magnet which extends into an opening in PC board. This arrangement using Hall Effect Sensors is more fully described in Applicant's related patent application Serial No. U.S. Ser. No. 13/847,607 filed on. Mar. 20, 2013 entitled High Efficiency Roller Shade, which is a Continuation of U.S. patent application Ser. No. 13/276,963, filed on. Oct. 19, 2011, which is a Continuation-in-Part of U.S. patent application Ser. No. 12/711,192, filed on Feb. 23, 2010 (now U.S. Pat. No. 8,299,734, issued on Oct. 30, 2012), the disclosures of which are incorporated herein by reference in their entireties, including any and all other related patent applications.

A motor housing shaft 34 extends outwardly from the exterior end 32 of motor housing 28. This motor housing shaft 34 is connected to an axel shaft 36 which extends outwardly from the exterior end 32 of motor housing 28 and protrudes outwardly from the right end 22 of roll tube 12.

Axel shaft 36 is formed of any suitable size, shape and design. As one example, in the arrangement shown, axel shaft 36 is a generally cylindrical member having a hollow interior end 38 which receives the motor housing shaft 34, however the two components 34, 36 can be coupled together by any other means or methods. The exterior end of axel shaft 36 includes a pair of axel flanges 40 which extend outwardly from the axis of axel shaft 36 and have a diameter greater than axel shaft 36. A bracket-mounting portion 42 is positioned between the pair of axel flanges 40. In one arrangement, as is shown, the bracket-mounting portion 42 is non-round or non-circular in shape, which is unlike the other portions of axel shaft 36. This non-round or non-circular shape is to prevent rotation of axel shafts 36 when mounted.

Axel shaft 36 extends through a bearing assembly 44 which rotatably connects axel shaft 36 to roll tube 12. Bearing assembly 44 has a bearing housing 46 which has a generally cylindrical exterior surface which is sized and shaped to fit within and frictionally engage the interior surface of the hollow interior 26 of roll tube 12. In one arrangement, bearing housing 46 has a clamshell design with a pair of generally mirror-image opposing halves which connect together to one another along a seam line. Bearing assembly 44 has a hollow interior with a pair of recesses 48 which are sized and shaped to receive and retain a bearing 50 in each recess 48. Bearings 50 are positioned over the axel shaft 36 between its hollow interior end 38 and axel flanges 40 and are held thereon by a clip 52 which fits within a groove in axel shaft 36. A ring 54 is connected to the exterior end of bearing housing 46 and extends outwardly therefrom. Ring 54 has a diameter greater than the hollow interior 26 of roll tube 12 and therefor prevents over insertion of bearing assembly 44 into hollow interior 26 of roll tube 12. This arrangement allows axel shaft 36 to remain stationary, or non-rotating, while the other portions of the architectural covering 10 rotate, namely the roll tube 12.

In an alternative arrangement, a dampener 55 is used instead of a motor housing 28.

Battery Tube Assembly:

A battery tube assembly 56 is connected to the architectural covering 10. Battery tube assembly 56 is formed of any suitable size, shape and design. As one example, in the arrangement shown, the battery tube assembly 56 includes an elongated hollow battery tube which is sized and shaped to receive a stack of conventional batteries therein within close and acceptable tolerances such as A, AA, B, C or D cell batteries. A battery sleeve is positioned between the battery tube and batteries to absorb dimensional variances between the batteries and the battery tube and to immobilize the batteries therein. Battery tube assembly 56 is electrically connected to motor housing 28 thereby powering the electrical components of motor housing 28.

Counterbalance Assembly:

A counterbalance assembly 58 is connected to architectural covering 10. Counterbalance assembly 58 is formed of any suitable size, shape and design. In one arrangement, as is shown, counterbalance assembly 58 includes a spring housing 60. Counterbalance assembly 58 and spring housing 60 are more fully described in Applicant's related patent application Ser. No. 61/827,102 filed May 24, 2013 entitled Planetary Gear System For A Counterbalancing Spring System In An Architectural Covering, which incorporated by reference herein including any related patent applications. Spring housing 60 has a generally cylindrical exterior surface which is sized and shaped to fit within the hollow interior of roll tube 12 and rotate as roll tube 12 rotates. The interior end of spring housing 60 is closed by an interior spring housing cap 62 thereby defining a hollow interior between the spring housing 60 and end cap 62. At least one, and as is shown, a plurality of, spring assemblies 64 are positioned within the spring housing 60. Each spring assembly 64 includes at least one power spring 66, or other form of spring. Alternatively, a plurality of spring assemblies 64 are connected together in end-to-end alignment to form spring housing 60. A spring shaft 68 extends through the spring housing 60, and/or the plurality of spring assemblies 64. Spring shaft 68 is connected at its exterior end the interior end of axel shaft 36 of bearing assembly 44. Spring shaft 68 is connected to the power springs 66 positioned within each spring assembly 64.

A power spring, also known as a clock, motor or flat coil spring, consists of a strip of spring material wound on an arbor and confined in a case or ring. Power springs store and release rotational energy in the form of torque, either through the central arbor or the case in which the power spring is retained or restrained.

Power spring 66 is formed of a plurality of wraps or layers of spring steel wrapped around it self and extends between a first end 70, or an interior end of the power spring 66, and a second end 72, or an exterior end of power spring 66. Interior end 70 of power spring 66 is connected to spring shaft 68. Spring shaft 68 is formed of any size, shape or design. In the arrangement shown, spring shaft has cylindrical or tubular shaped exterior surface around which power spring 66 wraps. When roll tube 12 and/or spring housing 60 is rotated, the interior end 70 or arbor of power springs 66 begins to wrap around inner spring shaft 68 thereby producing a counterbalancing torque as the power spring 66 is deformed out of its natural spring radius or its static spring radius.

The exterior end of spring housing 60 and/or spring assembly 64 is connected to bearing assembly 44. Bearing assembly 44 has a bearing housing 46 which has a generally cylindrical exterior surface which is sized and shaped to fit within and frictionally engage the interior surface of the hollow interior 26 of roll tube 12. In one arrangement, bearing housing 46 has a clamshell design with a pair of generally mirror-image opposing halves which connect together to one another along a seam line. Bearing assembly 44 has a hollow interior with a pair of recesses 48 which are sized and shaped to receive and retain a bearing 50 in each recess 48. Bearings 50 are positioned over the axel shaft 36 between its hollow interior end 38 and axel flanges 40 and are held thereon by a clip 52 which fits within a groove in axel shaft 36. A ring 54 is connected to the exterior end of bearing housing 46 and extends outwardly therefrom. Ring 54 has a diameter greater than the hollow interior 26 of roll tube 12 and therefor prevents over insertion of bearing assembly 44 into hollow interior 26 of roll tube 12. This arrangement allows axel shaft 36 to remain stationary, or non-rotating, while the other portions of the architectural covering 10 rotate, namely the roll tube 12. The exterior end of spring shaft 68 is connected to the interior end of axel shaft 36, such that when the roll tube 12 is rotated the axel shaft 36 and spring shaft 68 remain stationary. In this way power springs 66 are rotated around or loaded onto spring shaft 68.

Mounting Brackets:

The axel shafts 36 extending outwardly from the ends 22, 24 of roll tube 12 are connected to mounting brackets. In one arrangement, as is shown, there are two types of brackets shown, a top loading bracket 74 and a bottom loading bracket 76.

Top Loading Bracket or Right Bracket:

Top loading bracket 74 is formed of any suitable size, shape and design. In the arrangement shown, as one example, top loading bracket 74 includes an end plate 78 which is generally flat and planar in shape with an interior surface and an exterior surface positioned in generally parallel spaced relation to one another. End plate 78 is further generally square in shape with an opposing top edge and bottom edge, and an opposing front edge and back edge. A top mounting flange 80 is connected to the top edge of end plate 78 and extends inwardly in generally perpendicular spaced relation thereto. A front mounting flange 82 is connected to the front edge of end plate 78 and extends inwardly in generally perpendicular spaced relation thereto. A back mounting flange 84 is connected to the back edge of end plate 78 and extends inwardly in generally perpendicular spaced relation thereto. A bottom tab 86 is connected to the bottom edge of end plate 78 and extends inwardly in generally perpendicular spaced relation thereto. Bottom tab 86 is substantially smaller than the mounting flanges 80, 82, 84. Tab 86 and mounting flanges 80, 82, 84 are generally bent or folded inwardly from end plate 78 in the manufacturing process for cost effective manufacturing.

A recessed feature 88 is positioned in the end plate 78 and extends inwardly from the end plate 78 a distance. The recessed feature 88 provides clearance for connection of roll tube 12 and axel shaft 36 thereto without interference from the structure to which the architectural covering 10 is mounted. Recessed feature 88 is generally pressed or stamped inwardly from end pate 78. This recessed feature 88 allows for end plate 78 to be mounted flushly against a wall or window pocket, while still allowing for clearance axel shift 36. This allows for easier installation.

An axel opening 90 is positioned within the recessed feature 88 and is connected to axel slot 92. Axel opening 90 and axel slot 92 are formed of any suitable size, shape and design. Axel opening 90 allows for passage of the exterior axel flange 40 to pass there through, while axel slot 92 is sized and shaped to receive the bracket-mounting portion 42 of axel shaft 36 within close tolerance and to prevent rotation of axel shaft 36 when in position therein. In the arrangement shown, as one example, axel slot 92 has a pair of opposing sidewalls 94 that are positioned in generally parallel spaced relation to one another and terminate at their lower end in a rounded bottom edge 96 which connects the sidewalls 94. This shape mirrors the shape of bracket-mounting portion 42 of axel shaft 36. In this arrangement, the exterior axel flange 40 is inserted through the axel opening 90 and the bracket-mounting portion 42 is held by gravity within the axel slot 92. Due to the non-round nature of the axel slot 92 and the bracket-mounting portion 42, the axel shaft 36 is prevented from rotating therein as the roll tube 12 rotates.

Flanges 80, 82 and 84 and end plate 78 have a plurality of mounting slots 98 which receive conventional fasteners, such as screws or bolts, for mounting. To provide adjustability, the length of the mounting slots 98 are positioned in both lateral as well as the vertical or horizontal alignment. This allows for adjustability in the lateral direction as well as vertically or horizontally, depending the application.

A stop bracket 100 is connected to the front mounting flange 82. Stop bracket 100 has a front portion 102 and an end portion 104. Front portion 102 and end portion 104 are generally planar in shape and are positioned in generally perpendicular alignment to one another. Stop bracket 100 is installed into top loading bracket 74 by positioning the front portion 102 in frictional engagement with interior surface the front mounting flange 82; and the end portion 104 in frictional engagement with interior surface the end plate 78. Once in position, stop bracket 100 is then connected to end plate 78 and/or front mounting flange 82 using fasteners 106, such as screws or rivets. By positioning the front portion 102 and end portion 104 in close frictional engagement with the front mounting flange 82 and end plate 78, respectively, the top loading bracket 76 provides strength and rigidity to the stop bracket 100.

The bottom edge 108 and top edge 110 of the front portion 102 of stop bracket 100 extends below the bottom edge and above the top edge of front mounting flange 82, respectively, and are positioned in approximate planar alignment with the front surface of front mounting flange 82. The bottom edge 108 and the top edge 110 are used for mounting a front cover 112 onto the top loading bracket 74. To serve this purpose, the bottom edge 108 has a chamfered interior edge, and the top edge 110 has a chamfered exterior edge. Also, the top edge 110 is also positioned at the end of a resilient or flexible arm arrangement 114 which provides some give when connecting front cover to top loading bracket 74 so that front cover 112 can be snapped into place.

A stop member 115 is connected to and extends inwardly from the front portion 102 of stop bracket 100. Stop member 115 has a generally planar inner face that is positioned in angular alignment to the plane of front portion 102 and extends inwardly as the stop member 115 extends upwardly. In this way, when viewed from the side, stop member 115 defines a triangular shape. Stop member 115 provides a stopping force for bottom bar 16 when rolled upon roll tube 12. That is, as the roll tube 12 is almost fully rolled up, the bottom bar 16 engages the stop member 115 which pushes the bottom bar 16 into the wraps of shade material around the roll tube 12. This causes additional resistance which is sensed by the user manually opening the shade, or sensed by the motor which is motorizably opening the shade, and thereby stops opening of the shade. This is called a “hard stop” because the bottom bar 16 cannot move past the stop member 115 under any conditions.

Bottom Loading Bracket or Left Bracket:

Bottom loading bracket 76 is similar to, or a mirror image of, top loading bracket 74 with the differences described herein. The recessed feature 88 is essentially inverted as compared to the top loading bracket 74. That is, the recessed feature includes an axel opening 90 positioned below the axel slot 92. In this arrangement, the bottom edge of sidewalls 94 of axel slot 92 are connected to angled shoulders 116, which angle towards one another so as to provide guidance for axel shaft 36 towards axel slot 92 when inserted therein. The bottom edge of angled shoulders 116 connect to the axel opening 90. The axel opening of bottom loading bracket 76 is larger than top loading bracket 74 and is generally rectangular in shape with a generally flat bottom edge 118.

A second recessed feature 120 is pressed inward from the exterior surface of end plate 78. The top edge of second recessed feature 120 connects to the bottom edge 118 of axel opening 90. Second recessed feature 120 does not extend inward nearly as far as recessed feature 88.

A clip member 122 is connected to second recessed feature 120 and extends across axel opening 90 and covers a portion of axel slot 92 in bottom loading bracket 76. Clip member 122 has a bottom plate 124 which is generally flat and rectangular in shape. Bottom plate 124 is generally sized and shaped to fit within second recessed feature 120. Second recessed feature 120 is recessed a distance approximately equal to or greater than the thickness of bottom plate 124, so as to ensure that when bottom plate 124 is positioned within the second recessed feature 120 the exterior surface of end plate 78 is flush, flat and free of protrusions or obstacles that could interfere with mounting.

At least one alignment arm 126 is connected to the top edge of bottom plate 124. Alignment arms 126 are sized and shaped to reach over and align with, engage and hold end plate 78 adjacent the bottom edge 118 of axel opening 90. In this way, alignment arms 126 hold clip member 122 onto bottom loading bracket 76 and provide alignment to clip member 122. A fastener 127, such as a bolt, screw, rivet, or the like extend through bottom plate 124 and end plate 78 in second recessed feature 120 thereby connecting clip member 122 to bottom loading bracket 76.

A narrower neck portion 128 extends upwardly from bottom plate 124 and connects to plunger 130, which is also planar in shape. In one arrangement, plunger 130 has a recess, depression, corrugation or other feature 132 therein that provides additional strength and rigidity to plunger 130. An axel recess 134 is positioned in the top edge of plunger plate 130. Axel recess 134 is positioned in alignment with the center of axel slot 92 and matches the rounded top edge 96 of axel slot 92 and provides for nesting of bracket-mounting portion 42 of axel shaft 36 therein. Because second recessed feature 120 is not depressed as far inwardly as recessed feature 88, clip member 122 angles inwardly at a fold line or seam at or between the bottom of neck 128 and top of bottom plate 124. When clip member 122 is installed into the second recessed feature 120, plunger plate 130 is biased toward and in frictional engagement with the exterior surface of recessed feature 88 with a strong resilient force.

Materials:

In one arrangement, brackets 74, 76 and clip member 122 are formed of a metallic material for its strength, longevity, rigidity and ease of manufacture, whereas end covers 136 and stop bracket 100 are formed of a non-metallic material such as a plastic, composite, UHMW material, or the like. In an alternative arrangement brackets 74, 76 are formed of a non-metallic material such as plastic, composite, UHMW material, nylon, fiberglass, or any combination thereof or the like so as to ease manufacturing, reduce weight as well as to allow easier penetration of radio waves through the brackets 74, 76.

End Covers:

End covers 136 are connected to the exterior surface of end plates 78. End covers 136 are formed of any suitable size, shape and design. In one arrangement, as is shown, end covers 136 are generally planar in shape which generally match the size of brackets 74, 76, or are generally slightly oversized to the shape of brackets 74, 76. That is, in the arrangement shown where brackets 74, 76 are square, end covers 136 are generally square with a generally flat exterior surface extending in parallel spaced relation to a generally flat interior surface which terminates in generally flat and straight square top, bottom, front and back edges. A cover flange 138 extends inwardly a distance from the front edge of end covers 136 and provides an aesthetically pleasing finished look to brackets 74, 76 when installed.

A plurality of mounting features 140 are connected to the interior surface of end cover 136 and extend inwardly therefrom. Mounting features 140 are used to removeably and replaceably connect end covers 136 to brackets 74, 76. Mounting features 140 are formed of any suitable size, shape and design. In the arrangement shown, as one example, mounting features 140 are what are known as Christmas-tree-type mounting features, or push-connectors. These connectors include an elongated shaft with a plurality of flanges or branches that extend outwardly therefrom. These mounting features 140 are aligned with mounting holes in end plates 78 of brackets 74, 76. As the elongated shaft is forced through the mounting holes in end plates 78, the flanges or branches frictionally and tightly engage the end plate 78 thereby holding the end cover 136 onto the end plate 78. One advantage to this mounting system is that it provides for lateral adjustability. That is, in the even that mounting brackets 74, 76 are not mounted at the perfect position, the end covers 136 can be inserted to any position on mounting features 140, thereby providing some lateral adjustment.

Unit Frame:

A unit frame 142 has a generally L-shaped design and extends the length between mounting brackets 74, 76 and is used to cover and close the area between brackets 74, 76 and provide a finished aesthetic appearance.

In Operation:

Top loading bracket 74 and bottom loading bracket 76 are installed opposite one another into a window opening 144 adjacent a window 146, or to any other structure. While the arrangement shown shows the use of one top loading bracket 74 and one bottom loading bracket 76, two of either can be used by slightly modifying the method described herein. As set answer notification, while bottom loading bracket 76 is described as exactly that, “bottom loading” the recessed feature 88 and plunger 13 and all other related features can be inverted, or turned to the side thereby providing a top loading or side loading bracket with the safest advantages that plunger 130 will not let axel shift 36 escape from axel slot 92. The unit frame 142 is installed over the top mounting flange 80 and the back mounting flange 84.

Next, roll tube 12 having the motor housing 28, battery tube assembly 56 and spring housing 60 inserted therein is installed onto brackets 74, 76. To do so, one end of the roll tube 12, with axel shaft 36 extending outwardly therefrom is positioned adjacent the top loading bracket 74. The exterior axel flange 40 is inserted into the axel opening 90 of recessed feature 88 and the bracket-mounting portion 42 is allowed to settle into the axel slot 92 by way of the force of gravity.

Next, the opposite end of roll tube 12 is inserted into bottom loading bracket 76. To do so, the opposite end of the roll tube 12, with axel shaft 36 extending outwardly therefrom is positioned adjacent the bottom loading bracket 76. The exterior axel flange 40 is inserted into the axel opening 90 of recessed feature 88 and the bracket-mounting portion 42 is forced upwardly into the axel slot 92. As the axel shaft 36 is forced upward the angled shoulders 116 guide the axel shaft 36 into the axel slot 92. As the axel shaft 36 is forced upward, the axel shaft 36 engages the neck portion 128 and/or the plunger portion 130 of clip member 122. Due to the clip member's inward bias, as the axel shaft 36 is forced upward the clip member 122 deflects outward and allows the axel shaft 36 to pass. Once the axel shaft 36 passes the upper end of clip member 122, clip member 122 snaps back to its original inward bias in frictional engagement with the exterior surface of end plate 78 in recessed feature 88. In this way, the locking feature provided by clip member 122 provides a loud “snap” or “click” noise which instantaneously provides audible confirmation to the installer that the clip member 122 has locked the axel shat 36 in axel slot 92. In addition to this snapping or clicking noise, the locking feature can also be felt by the installer through vibrations when installing the shade into the brackets which provides yet another confirmation to the installer that the clip member 122 has locked the axel shaft 36 in axel slot 92. In addition, in this way the locking feature of bottom loading bracket 76 is automatic, and does not require any effort or manipulation by the installer to put the locking feature into place.

Once the roll shade 12 is lowered, the bracket-mounting portion 42 of axel shaft 36 settles into the axel recess 134 of clip member 122. In this way, axel shaft 36 is now prevented from unintentionally escaping the axel slot 92.

Once the roll tube 12 is installed into the brackets 74, 76, the end covers 136 are inserted over the exterior sides of end plates 78 of brackets 74, 76. In addition, front cover 112 is inserted over brackets 74, 76, or more specifically, over the top edge 110 and bottom edge 108 of stop bracket 100.

To remove the roll tube 12 from bottom loading bracket 76, the roll tube 12 must be lifted within the axel slot 92 such that the axel shaft 36 disengages the clip member 122. Next, a tool, such as a flat head screw driver is inserted between the end plate 78 and clip member 122 and clip member 122 is deflected away from end plate 178. Once enough clearance is gained from the clip member 122, the roll tube 12 can be lowered.

Actuation:

In this arrangement, the motor of architectural covering 10 can be actuated in any one of a plurality of methods and manners. Motorized control of architectural covering 10 can be implemented in several ways. As examples, the motor can be actuated by tugging on the architectural covering 10, by using a remote control device, using RF communication, by using a voice command and a voice command module, an internet enabled application, or any other method.

Tugging:

One method of actuating the motor is through tugging the architectural covering 10. This method and system is more fully described in Applicant's related patent application entitled Low-Power Architectural Covering Ser. No. 61/811,650 filed on Apr. 12, 2013 which is fully incorporated by reference herein. A tug is defined a small manual movement of the architectural covering. This tug is sensed by a tug sensor such as an accelerometer, hall effect sensors, reed switch or the like as is more fully described in Applicant's related patent applications. When the tug sensor senses the tug, the system is woken up from a sleep state. In sleep state, power use is minimized to maximize battery life. When the system is woken up, the tug sensor senses the tug and the Microprocessor deciphers the tug and determines how to actuate the motor.

In one arrangement, the microprocessor is programmed to recognize, one, two, three, or more tugs separated by a predetermined amount of time, such as between a quarter second and one and a half seconds. However any other amount of time between tugs is here by contemplated such as ¼ second, ½ second, ¾ second, 1 second, 1¼ seconds, 1½ seconds, 1¾ seconds, 2 seconds, and the like. When microprocessor detects a single tug, pursuant to instructions stored in the memory microprocessor instructs the motor to go to a first corresponding position, such as open. When microprocessor detects two tugs, pursuant to instructions stored in memory, the microprocessor instructs the motor to go to a second corresponding position, such as closed. When microprocessor detects three tugs, pursuant to instructions stored in memory microprocessor instructs motor to go to a third corresponding position, such as half open. Any number of tugs and positions can be programmed.

Remote Control and Voice Control Operation:

One method of actuating the motor 48 is through using a wireless remote 148. This method and system is more fully described in Applicant's related patent application entitled System And Method For Wireless Voice Actuation Of Motorized Window Coverings Ser. No. 61/807,846 filed on Apr. 3, 2013 which is fully incorporated by reference herein. In that application, as is contemplated herein, a wireless remote 148 is actuated by the user, by pressing a button. When actuated, the wireless remote 148 transmits an electromagnetic signal over-the-air, which is received by the antenna of the motor housing. Once the antenna receives the electromagnetic signal it is transmitted to a receiver or transceiver which converts the signal and transmits it to a microprocessor. The microprocessor interprets the signal based on instructions stored in the memory and actuates the architectural covering 10 to the predetermined position. As is also presented in that application, is a voice actuation module 150, which receives a user's voice command, converts it to an electromagnet signal which is received by architectural covering 10 in the manner described herein.

Internet Control and Operation:

One other method of actuating the motor is through use of the internet and use of an electronic device. This method and system is more fully described in Applicant's related patent application entitled System And Method For Wireless Communication With And Control Of Motorized Window Coverings Ser. No. 61/807,804 filed on Apr. 3, 2013 which is fully incorporated by reference herein, including any related patent applications. In that application, as is contemplated herein, the motor is actuated by a user having an internet enabled handheld device, such as a laptop, tablet or smartphone, which transmits a signal through the internet which is received at a gateway which then transmits an electromagnetic signal to the architectural coverings 10 as is described herein.

From the above discussion it will be appreciated that the bottom load bracket for an architectural covering and method of use presented herein improves upon the state of the art.

Specifically, the bottom load bracket for an architectural covering and method of use shown and described herein improves upon the state of the art, is easy to use, is efficient, is simple in design, is inexpensive, has a minimum number of parts, has an intuitive design, allows for bottom loading of a roll shade into a bracket and further prevents the roll shade from unintentionally escaping the brackets during use.

It will be appreciated by those skilled in the art that other various modifications could be made to the device without parting from the spirit and scope of this invention. All such modifications and changes fall within the scope of the claims and are intended to be covered thereby.

What is claimed:

1. A mounting bracket for an architectural covering, comprising:
an end plate having an exterior surface and an interior surface;
a recessed feature in the end plate and extending inwardly therefrom;
an axel slot in the recessed feature;
the axel slot connected to an axel opening;
a clip member connected to the end plate and biased to engage the clip member;
wherein the clip member covers a portion of the axel slot and the axel opening; and
wherein when an axel of an architectural covering is inserted into the axel slot the clip member is deflected away to allow the axel to enter the axel slot, and once the axel passes the clip member, the clip member closes the axel slot and thereby locking the axel in the axel slot.

2. The mounting bracket of claim 1 wherein the clip member is connected to the exterior surface of the end plate.

3. The mounting bracket of claim 1 wherein a top edge of the clip member has an axel recess therein.

4. The mounting bracket of claim 1 wherein the mounting bracket is bottom loaded.

5. The mounting bracket of claim 1 wherein the axel slot is connected to the axel opening by a pair of opposing shoulders that angle toward one another.

6. The mounting bracket of claim 1 wherein a front flange extends inwardly from a front edge of the end plate and an angled stop member is positioned on an inward side of the front flange.

7. An architectural covering comprising:
a roll tube extending a length between a first end and a second end;
shade material connected to the roll tube;
a first axel extending outwardly from the first end;
a second axel extending outwardly from the second end;
a top loading bracket connected to the first axel extending outwardly form the first end;
a bottom loading bracket connected to the second axel extending outwardly from the second end;
wherein the bottom loading bracket has a detachable clip member which covers a portion of an axel slot and is biased towards the bottom loaded bracket; and
wherein when the second axel is installed into the bottom loading bracket the clip member deflects to allow the second to enter the axel slot.

8. The architectural covering of claim 8 further comprising wherein the top loading bracket has an axel slot, wherein the first axel is inserted into the axel slot of the top loading bracket from above.

9. The architectural covering of claim 8 further comprising wherein the second axel is forced upwardly into the axel slot of the second bracket.

10. The architectural covering of claim 8 wherein when the second axel is installed into the axel slot of the bottom loading bracket the clip member locks the axel into the axel slot.

11. A method of installing an architectural covering, the steps comprising;
providing a roll tube having a first axel extending outwardly from a first end of the roll tube;
providing a bracket having an axel opening and an axel slot therein, and a clip member biased towards the bracket such that the clip member that partially covers the axel opening and the axel slot;
inserting the axel of the roll tube into the axel opening;
engaging the axel with the clip member; and
deflecting the clip member as the axel is inserted into the axel slot.

12. The architectural covering of claim 13 wherein the clip member locks the axel into the axel slot.

13. The architectural covering of claim 13 wherein the clip member is biased towards the bracket.

14. The architectural covering of claim 13 wherein the axel is forced upwardly into the axel slot.
